(19) United States
(12) Patent Application Publication
(10) Pub. No.: US 2019/0252960 A1
(43) Pub. Date: Aug. 15, 2019

(54) ELECTRIC MOTOR DRIVE SYSTEM FOR POWERING VEHICLE WHEELS

(71) Applicant: John K. Grady, Ayer, MA (US)

(72) Inventor: John K. Grady, Ayer, MA (US)

(21) Appl. No.: 16/273,574

(22) Filed: Feb. 12, 2019

Related U.S. Application Data
(60) Provisional application No. 62/629,926, filed on Feb. 13, 2018.

(51) Int. Cl. H02K 19/10; H02K 19/20; H02K 3/28

(52) U.S. Cl. CPC H02K 19/103; H02K 3/28; H02K 19/20

(57) ABSTRACT

An electric motor drive system comprising: a projection mounted to a frame of a vehicle, the projection comprising a motor stator fixed to the projection, wherein the motor stator comprises a plurality of poles electrically connected to a varying electrical source; an axle rotatably mounted to the projection; and a wheel hub mounted to the axle for rotation relative to the projection, the wheel hub comprising a motor rotor, wherein the motor rotor comprises a plurality poles rotatable about the motor stator.

### REFERENCE TO PENDING PRIOR PATENT APPLICATION

This patent application claims benefit of pending prior U.S. Provisional Patent Application Ser. No. 62/629,926, Feb. 13, 2018 by John K. Grady for ELECTRIC MOTOR DRIVE SYSTEM FOR POWERING VEHICLE WHEELS (Attorney's Docket No. GRADY-6 PROV), which patent application is hereby incorporated herein by reference.

### FIELD OF THE INVENTION

This invention relates to electric motors in general, and more particularly to electric motor drive systems for powering vehicle wheels.

### BACKGROUND OF THE INVENTION

Looking first at FIGS. 1 and 2, a conventional induction motor 5 typically comprises a fixed stator or core 10 comprising a plurality of poles 15, and a rotatable rotor 20 comprising a plurality of generally short-circuited pole windings 25. Rotatable rotor 20 is movably disposed within fixed stator 10. When poles 15 of fixed stator 10 are appropriately electrically energized, rotating magnetic fields can be created within the interior of fixed stator 10 so that appropriate electrical currents are induced within the generally short-circuited pole windings 25 of rotatable rotor 20 so that windings 25 of rotatable rotor 20 are sequentially attracted toward, or repelled from, poles 15 of fixed stator 10, whereby to cause rotation of rotatable rotor 20 within fixed stator 10. A drive shaft 30 is attached to rotatable rotor 20 so as to provide output power from induction motor 5.

In one common construction, and looking now at FIG. 3, rotatable rotor 20 comprises a plurality of copper bars 35 which extend between a pair of copper rings 40 so as to form a so-called “squirrel cage” rotor. Drive shaft 30 is secured to copper rings 40 so that drive shaft 30 is turned when the “squirrel cage” rotor is rotatably driven within fixed stator 10.

There are also existing in the prior art “inside-out” induction motors wherein the fixed stator is disposed within the interior of a rotatable rotor 20.

When electric motors are used to drive the wheels of a vehicle, the drive shaft of the electric motor is mechanically connected to the axle which extends between two wheels, with the drive shaft of the electric motor turning the axle of the two wheels, often through a differential gear set, and thereby driving the wheels of the vehicle. However, with this arrangement, the axle must run across the width of the vehicle, which takes up space within the vehicle.

### SUMMARY OF THE INVENTION

The present invention provides an “inside-out” induction motor to directly drive a wheel of a vehicle, wherein the fixed stator is disposed within the interior of a rotatable rotor 20, wherein the car frame or suspension is configured to support the fixed stator, and wherein the wheel rim itself is mechanically and electrically configured to function as the rotatable rotor of the induction motor, in a magnetic and electrical sense, as well as to serve as a functional tire-mounting rim. As a result of this construction, when the poles of the fixed stator are appropriately electrically energized, rotating magnetic fields can be created around the exterior of the fixed stator so that appropriate electrical currents are induced within the poles of the rotatable wheel rim (preferably made of aluminum) so that the induced poles of the rotatable rotor (now the wheel rim itself) are sequentially attracted to the poles of the fixed stator, whereby to cause rotation of the rotatable rim (a unitary assembly) around the fixed stator.

In one preferred form of the invention, there is provided an electric motor drive system comprising:

a projection mounted to a frame of a vehicle, the projection comprising a motor stator fixed to the projection, wherein the motor stator comprises a plurality of poles electrically connected to a varying electrical source;

an axle rotatably mounted to the projection; and

a wheel hub mounted to the axle for rotation relative to the projection, the wheel hub comprising a motor rotor, wherein the motor rotor comprises a plurality poles rotatable about the motor stator.

In another preferred form of the invention, there is provided a method for driving a vehicle, the method comprising:

providing an apparatus comprising:
a projection mounted to a frame of a vehicle, the projection comprising a motor stator fixed to the projection, wherein the motor stator comprises a plurality of poles electrically connected to a varying electrical source;
an axle rotatably mounted to the projection; and
a wheel hub mounted to the axle for rotation relative to the projection, the wheel hub comprising a motor rotor, wherein the motor rotor comprises a plurality poles rotatable about the motor stator; and

sequentially energizing the poles of the motor stator so as to create a rotating stator magnetic field, whereby to induce an electrical current in the poles of the motor rotor so that the poles of the motor rotor are sequentially attracted to, and repelled from, the poles of the motor stator, thereby rotating the wheel hub.

In another preferred form of the invention, there is provided a vehicle wheel comprising a wheel hub, wherein the wheel hub comprises a motor rotor comprising a plurality of poles for rotation about a motor stator.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIGS. 1 and 2 are schematic view showing a conventional induction motor;

FIG. 3 is a schematic view showing a “squirrel cage” rotor for an induction motor; and

FIGS. 4 and 5 are schematic views showing a novel electric motor drive system for powering vehicle wheels.

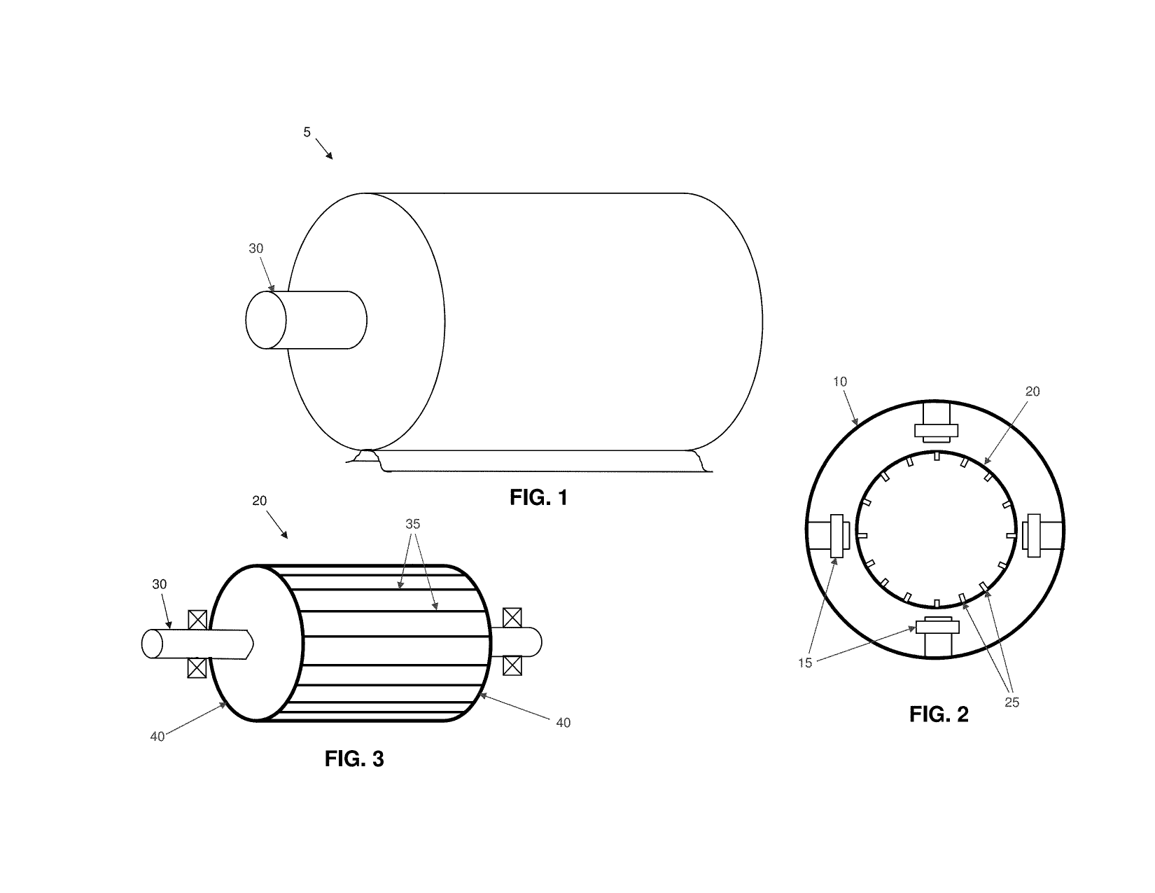

### DETAILED DESCRIPTION OF THE INVENTION

The present invention provides an “inside-out” induction motor to directly drive a wheel of a vehicle, wherein the fixed stator is disposed within the interior of a rotatable rotor, wherein the car frame or suspension is configured to support the fixed stator, and wherein the wheel rim itself is mechanically and electrically configured to function as the rotatable rotor of the induction motor, in a magnetic and electrical sense, as well as to serve as a functional tire-mounting rim. As a result of this construction, when the poles of the fixed stator are appropriately electrically energized, rotating magnetic fields can be created around the exterior of the fixed stator so that appropriate electrical currents are induced within the poles of the rotatable wheel rim (preferably made of aluminum) so that the induced poles of the rotatable rotor (now the wheel rim itself) are sequentially attracted to the poles of the fixed stator, whereby to cause rotation of the rotatable rim (a unitary assembly) around the fixed stator.

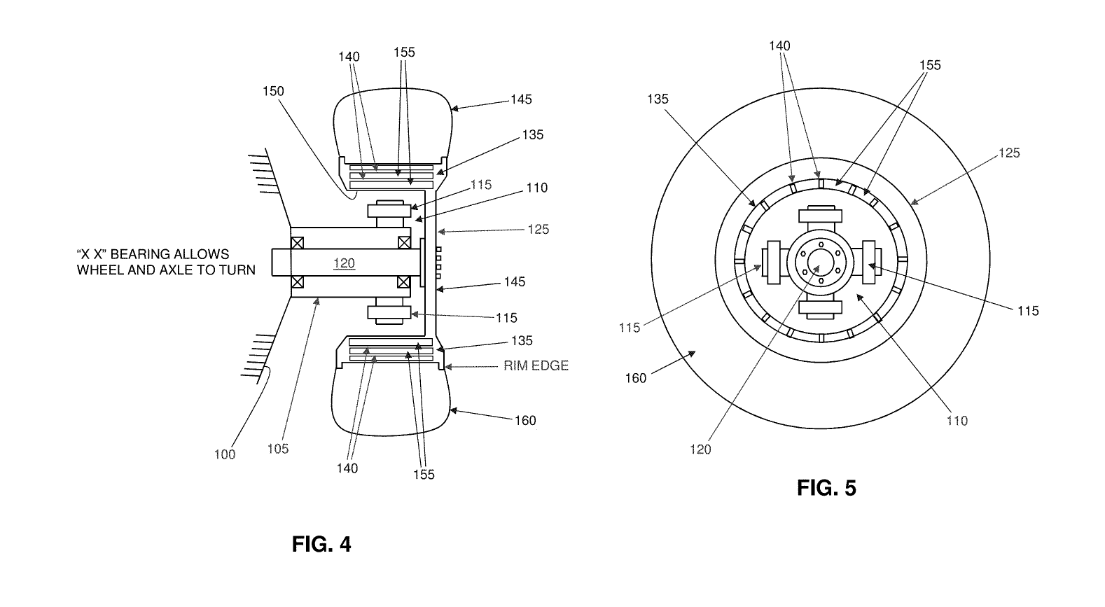

More particularly, in one preferred construction, and looking now at FIGS. 4 and 5, a car frame 100 includes a lateral projection 105 mounted to a normal vehicle suspension system (e.g., spring and damper, etc.) which functions as a support for fixed stator 110. Fixed stator 110 comprises poles 115. A short axle 120 extends through lateral projection 105 and is rotatable relative thereto. Wheel hub 125 is secured to axle 120 so that wheel hub 125 is rotatable relative to lateral projection 105 of car frame 100. Wheel hub 125 comprises a rotatable motor rotor 135. Rotatable motor rotor 135 comprises poles 140, embedded in or made as a part of wheel hub 125. As a result of this construction, when poles 115 of fixed stator 110 (mounted to lateral projection 105 extending out of car frame 100) are appropriately electrically energized, rotating magnetic fields can be created around the exterior of the rotationally-fixed stator 110 so that appropriate electrical currents are induced within windings 140 of rotatable rotor 135 (which is formed as part of wheel hub 125) so that poles 140 formed at rotatable rotor 135 are sequentially attracted to, and repelled from, poles 115 of fixed stator 110, whereby to cause rotation of rotatable rotor 135 (and hence rotation of wheel hub 125) around the fixed stator 110.

In one preferred form of the invention, rotatable rotor 135 comprises a “squirrel cage” construction, and is formed integral with wheel hub 125 by machining “windows” or slots into an electrically-conductive (e.g., aluminum) wheel hub, with the remaining material between the windows functioning as the windings for rotatable rotor 135. By way of example but not limitation, wheel hub 125 may comprise a face 145 for mounting (e.g., by bolting) to axle 120, and a hollow cylinder 150 extending perpendicular to face 145 and co-axial with axle 120, with rotatable rotor 135 being formed by machining windows 155 into the body of hollow cylinder 150, with the elongated poles 140 of rotatable rotor being formed by the material between windows 155. Air sealing (for mounting an inflatable tire 160 to wheel hub 125) can be achieved by disposing non-magnetic materials (such as epoxy or rubber-like rim liners) in the windows 155.

Significantly, by providing an “inside-out” induction or synchronous motor to directly drive a wheel of a vehicle, wherein the fixed stator is disposed within the rotatable rotor and the rotatable rotor is combined with the wheel rim, and further wherein the car frame suspension is configured to support the fixed stator, and the inner width of the wheel rim is configured to function as the rotatable rotor, each wheel rim itself can be directly driven by its own induction motor winding, thereby providing simple and effective four-wheel drive. In addition, axles may no longer need to run across the width of a vehicle.

Various known independent spring-type suspensions can be used to support the frame extensions.

It should be appreciated that the present invention may be applied to a wide range of motor vehicles, e.g., cars, trucks, motorcycles, powered bicycles, etc.

Further, embedded magnets or variable reluctance motor designs can be used this same way, with wheel rims configured as needed.

### Modifications

It should also be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. An electric motor drive system comprising:
a projection mounted to a frame of a vehicle, the projection comprising a motor stator fixed to the projection, wherein the motor stator comprises a plurality of poles electrically connected to a varying electrical source;
an axle rotatably mounted to the projection; and
a wheel hub mounted to the axle for rotation relative to the projection, the wheel hub comprising a motor rotor, wherein the motor rotor comprises a plurality poles rotatable about the motor stator.

2. An electric motor drive system according to claim 1 wherein the motor rotor comprises a “squirrel-cage” construction comprising a plurality of elongated poles separated by windows, wherein the plurality of elongated poles extend substantially parallel to the center axis of the axle and rotate about the motor stator.

3. An electric motor drive system according to claim 2 wherein the motor rotor is formed integral with the wheel hub.

4. An electric motor drive system according to claim 3 wherein the wheel hub comprises a face for mounting to the axle, and a hollow cylinder extending perpendicular to the face and coaxial with the axle, and further wherein the motor rotor is formed by machining windows into the hollow cylinder, with the elongated poles of the motor rotor being formed by the material between the windows.

5. An electric motor drive system according to claim 4 wherein non-magnetic material is disposed in the windows of the wheel hub so as to form an air-tight structure.

6. An electric motor drive system according to claim 1 wherein a tire is mounted to the wheel hub.

7. An electric motor drive system according to claim 1 wherein the projection is mounted to the frame of the vehicle via a suspension system.

8. An electric motor drive system according to claim 1 wherein the axle extends no further than the midway point of the frame of the vehicle.

9. An electric motor drive system according to claim 1 wherein the wheel hub is mounted to the axle by bolts.

10. An electric motor drive system according to claim 1 wherein the wheel hub is made of aluminum.

11. A method for driving a vehicle, the method comprising:
providing an apparatus comprising:
a projection mounted to a frame of a vehicle, the projection comprising a motor stator fixed to the projection, wherein the motor stator comprises a plurality of poles electrically connected to a varying electrical source;
an axle rotatably mounted to the projection; and
a wheel hub mounted to the axle for rotation relative to the projection, the wheel hub comprising a motor rotor, wherein the motor rotor comprises a plurality poles rotatable about the motor stator; and
sequentially energizing the poles of the motor stator so as to create a rotating stator magnetic field, whereby to induce an electrical current in the poles of the motor rotor so that the poles of the motor rotor are sequentially attracted to, and repelled from, the poles of the motor stator, thereby rotating the wheel hub.

12. A vehicle wheel comprising a wheel hub, wherein the wheel hub comprises a motor rotor comprising a plurality of poles for rotation about a motor stator.

13. A vehicle wheel according to claim 12 wherein the motor rotor comprises a “squirrel-cage” construction comprising a plurality of elongated poles separated by windows, wherein the plurality of elongated poles extend substantially parallel to one another.

14. A vehicle wheel according to claim 13 wherein the motor rotor is formed integral with the wheel hub.

15. A vehicle wheel according to claim 14 wherein the wheel hub comprises a face for mounting to an axle, and a hollow cylinder extending perpendicular to the face and coaxial with the axle, and further wherein the motor rotor is formed by machining windows into the hollow cylinder, with the elongated poles of the motor rotor being formed by the material between the windows.

16. A vehicle wheel according to claim 12 wherein the wheel hub is mounted to the axle by bolts.

17. A vehicle wheel according to claim 12 wherein the wheel hub is made of aluminum.

18. A vehicle wheel according to claim 12 wherein non-metallic material is disposed in the windows of the wheel hub so as to form an air-tight structure.

19. A vehicle wheel according to claim 12 wherein a tire is mounted to the wheel hub.
